(19) United States
(12) Patent Application Publication
(10) Pub. No.: US 2012/0251256 A1
(43) Pub. Date: Oct. 4, 2012

(54) CUTTING TOOL FOR CONTROL OF SURFACE ROUGHNESS

(75) Inventor: David H Shea, Lake Orion, MI (US)

(73) Assignee: GM GLOBAL TECHNOLOGY OPERATIONS LLC, Detroit, MI (US)

(21) Appl. No.: 13/339,564

(22) Filed: Dec. 29, 2011

Related U.S. Application Data
(60) Provisional application No. 61/471,632, filed on Apr. 4, 2011.

(51) Int. Cl. B23D 77/12; B23D 77/14

(52) U.S. Cl. 408/145

(57) ABSTRACT

A reamer reams a tapered hole in a casting to provide a desired surface roughness of the walls defining the tapered hole. The reamer includes a shank having at least one cutting tool of diamond material, the cutting face extends along a tapered length to a length corresponding to the length of the tapered hole. The cutting face has a plurality of undulations along the cutting face. The undulations include alternating crests and troughs that machine the walls of the tapered hole and provide thereon a surface roughness within desired limits of surface roughness.

### FIELD OF THE INVENTION

The present invention relates to a cutting tool and more particularly relates to a cutting tool having an undulating cutting surface for providing precise control of surface roughness.

### BACKGROUND OF THE INVENTION

It is common in the machining of metal parts to seek to obtain a desired surface roughness of the machined surfaces. For example, in the machining of aluminum castings for automotive transmissions, it is common to have fluid passages that must be plugged. A commonly used plug is an expansion plug manufactured by The Lee Company, Westbrook, Conn., USA, and sold under the trademark “Betaplug”. The Betaplug is a two-piece tapered expansion plug specifically engineered to seal fluid passages in metal castings without the use of threads or sealants. Lands and grooves provided on the outside of the plug bite into the wall of a tapered hole in the casting. A typical beta plug installation is shown in FIG. 10, where Betaplug 2 has been inserted in a tapered hole 4 to plug a passage 6 in a cast automotive transmission housing 8. In order to obtain a fluid tight seal, the tapered hole in which the Betaplug will be installed should have a surface finish roughness of 0.8 to 3.2 μm under the roughness parameter known as Ra. Ra is the arithmetic average of the roughness, including the finely spaced surface irregularities such as the height, width, direction, and shape, of the dominant surface pattern.

The tapering of the hole in the casting, and the surface roughness of the walls of the hole is determined by the tooling used to finish the hole. These holes are typically finished by a tapered reamer which is plunged into the hole in the casting. Reamers made of carbide can be employed, but have relatively short tool life. Therefore, in order to obtain high cutting rates and long tool life, the reamers are typically provided with a cutting edge made of industrial diamond. The industrial diamond material is itself very difficult to machine to desired shape and therefore it is difficult to provide the diamond material with a machining surface that will in turn create the specified finish roughness of 0.8 to 3.2 μm Ra.

I have discovered a new and improved cutting tool having an undulating cutting surface that allows us to achieve finely controlled surface roughness on machined surfaces.

### SUMMARY OF THE INVENTION

A reamer reams a tapered hole in a casting to provide a desired surface roughness of the walls defining the tapered hole. The reamer includes a shank having at least one cutting tool of diamond material having a cutting face that extends along a tapered length to a length corresponding to the length of the tapered hole. The cutting face has a plurality of undulations along the cutting face. The undulations include alternating crests and troughs that machine the walls of the tapered hole and provide thereon a surface roughness within desired limits of surface roughness.

### BRIEF DESCRIPTION OF THE DRAWINGS

The present invention will become more fully understood from the detailed description and the accompanying drawings, wherein:

FIG. 1 is a view showing a reamer reaming a tapered hole in a casting.

FIG. 2 is an enlarged view of the reamer showing a cutting face of industrial diamond material.

FIG. 3 is an end view of the reamer of FIG. 2.

FIG. 4 is another end view but showing only the endmost part of the reamer having the diamond cutting face.

FIG. 5 is an enlargement of the diamond cutting face of FIG. 2.

FIGS. 6, 7, 8, and 9 show alternative embodiments of the diamond cutting face.

FIG. 10 shows a Betaplug installed in a tapered hole.

### DETAILED DESCRIPTION OF THE EXEMPLARY EMBODIMENTS

The following description of certain exemplary embodiments is merely exemplary in nature and is not intended to limit the invention, its application, or uses.

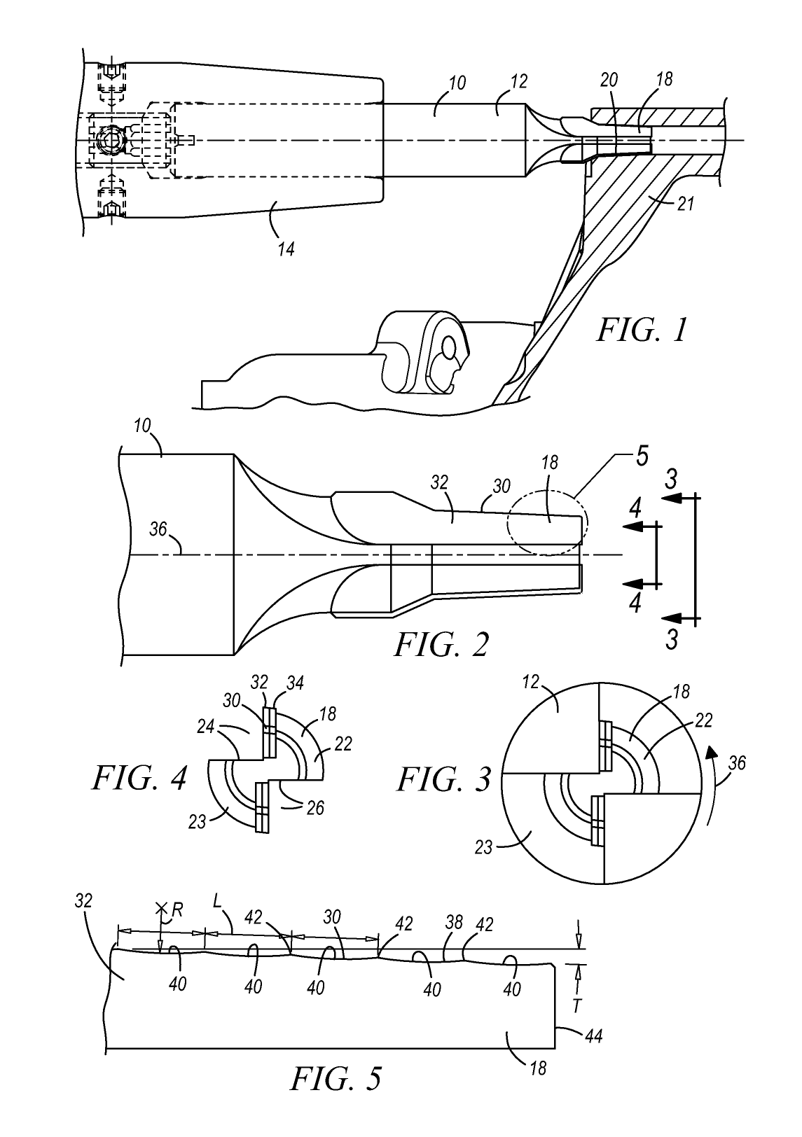

Referring to FIG. 1, a reamer 10 has a shank 12 rotated by a chuck 14. The reamer 10 has a tip 18 that is finishing a tapered hole 20 in a casting 21.

As seen in FIGS. 2, 3 and 4, the tip 18 of the reamer has a flute 22 and a flute 23 which are separated by notches 24 and 26. Flute 22 has a cutting face 30 provided by a polycrystalline diamond (PCD) cutting tool 32 mounted on a carbide backing plate 34. The carbide backing plate 34 is brazed in a recess in the flute 22. The polycrystalline diamond (PCD) cutting tool 32 is in the shape of a relatively thin wafer as seen in FIGS. 2, 3, and 4, and is made by sintering many micro-size single diamond crystals at high temperature and high pressure, as either a diamond wafer on a backing of carbide, or forming a “vein” of diamond within a carbide wafer or rod. The PCD cutting tool is cut to shape by electrical discharge machining (EDM) or grinding. In operation, the chuck 14 will rotate the reamer 10 in the counterclockwise direction of FIG. 3. The reamer 10 has a centerline axis 36.

Referring to FIG. 5, the cutting face 30 of the PCD cutting tool 32 is precisely shaped and tapered in order to obtain a precise surface roughness on the walls of the tapered hole that is being reamed in FIG. 1. In order to meet the specifications of the manufacturer of the Betaplug, it is known that the tapered hole should have a minimum tapered length of 10 mm, a taper of 2.35° on each wall, and a surface finish of 0.8-3.2 μm Ra.

I have discovered that by precisely shaping the cutting face 30 of the PCD cutting tool 32, I can consistently obtain the required surface finish. In particular, in FIG. 5, it is seen that the cutting face 30 has a taper, designated “T”, along its length. Furthermore, the cutting face 30 is an undulated surface 38 comprised of a series of wavelike undulations of alternating troughs and crests.

In FIG. 5, these wavelike segments are an undulated surface 38 having a series of semicircular troughs or indents 40 that are machined into the cutting face 30. These troughs 40 are each semicircular in shape and have a radius R, and length L. These semicircular troughs 40 are linked end-to-end progressively, joining one another at cusps or crests 42, and taper downwardly at angle T along the length of the taper of the cutting face 30. A typical radius R is about 0.79 millimeters, and typical length L for each indent is about 0.180 millimeters. As seen in FIG. 5, a plurality of these troughs 40 are connected end to end at crests 42 in order to provide the desired overall length of 10 mm as required to accommodate the length of the Betaplug. As seen in FIG. 5, each of the succeeding crests 42 is closer to the centerline axis 36 and the preceding crest 42 as the undulations proceed progressively down the tapered T toward the end 44 of the reamer 10.

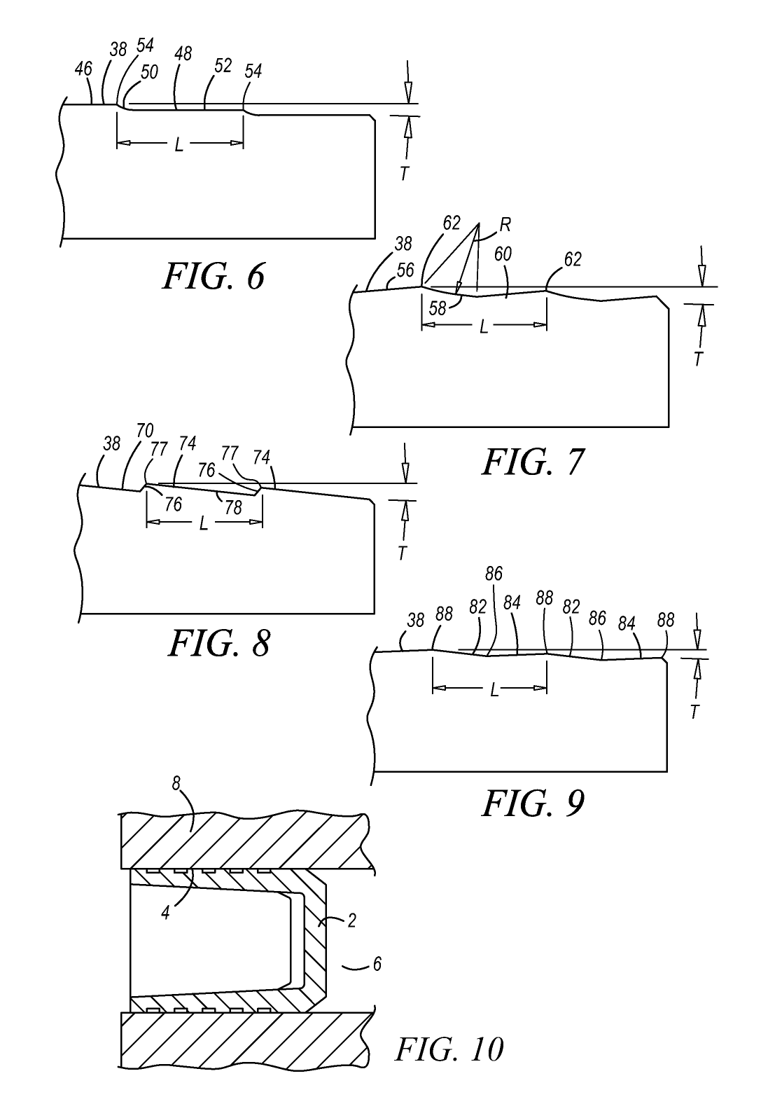

FIGS. 6-9 show alternative shapes for the undulated surface 38 of the cutting face 30. In FIG. 6 the undulated surface 38 is a waveform or stepped trough surfaces 46 comprised of a series of descending steps 48, each including a curved down ramp 50 and a flat tread 52 that extends between crests 54. A series of these descending steps 48 progress along the length of the undulated surface 38 to achieve the taper T. The radius of the curved down ramp 50 is 0.075 mm, conveniently defined by the 0.15 mm diameter of the wire halo used in the electrode discharge machining process.

In FIG. 7, the undulated surface 38 is a series of trough waveforms 56, with each wave made up of a semicircular curved surface 58 linked to a inclined flat surface 60. The undulated surface 38 is made up of a progression of these waveforms 56, with the waveforms connected at crests 62, and progressing ever downwardly along the taper T.

In FIG. 8, the undulated surface 38 is comprised of a saw tooth waveform surface 70 made up of teeth 74. Each tooth 74 has a riser 76 defining a crest 77, followed by a reclining flat 78 that reclines along the length of the reamer 10 to connect with the next riser 76. A plurality of these teeth 74 progress end to end along the taper T. The radius of the riser 76 is 0.075 mm, conveniently defined by the 0.15 mm diameter of the halo wire used in the electro discharge machining process.

In FIG. 9, the undulated surface 38 is made up of waveforms including a reclining flat 82 and an inclining flat 84 that connect together to form alternating troughs 86 and crests 88. Together, the length of a reclining flat 82 and a inclining flat 84 make up the length L of a single waveform 80. A progression of these waveforms 80 is provided along the taper T of the reamer.

Thus, it is seen that by providing an undulated surface 38 along the length of the taper of the reamer, and by controlling the shape and size of the undulations of the undulated surface 38, the improved cutting tool of this invention is able to provide a predetermined surface roughness. It will be understood that the dimensions disclosed herein are useful in obtaining the 0.8-3.2 μm Ra surface roughness desired for installation of the Betaplug. However, the teachings of this invention can be modified to obtain other precise surface roughness goals by varying the shape and size of the waveform of the undulated surface of this invention to achieve the desired surface roughness on a given tapered hole.

The terms “descending”, “reclining”, and “curved down”, are used herein to describe a surface that is generally angled or tapering or curved and downwardly along the taper T of the reamer. The terms “inclined”, “inclining”, and “rising” are used herein to describe a surface that is generally angled or tapering outwardly and away from the taper T of the reamer.

The term “curved” herein is used to describe a surface that has a radius. And the term “flat” used herein is used to describe a surface that is not curved and does not have a radius.

The waveforms herein of FIGS. 5-9 are generally convex in shape, but can be inverted to provide waveforms that are generally concave.

In addition, it will be understood that although the drawings herein show the example of a tapered reamer that is plunged into a hole, the undulated cutting tool face of this invention can also be used in a reamer that would be orbited within a hole.

In addition, it will be understood that the undulated cutting tool face of this invention is not limited to use in reamers, but could also be used in spot facing tools, in orbiting milling tools, and other types of cutting tools.

Furthermore, although the undulated cutting tool face is disclosed herein in relation to a diamond cutting tool, the undulated cutting face can also be employed in cutting tools made of carbide, ceramic, cubic boron nitride, and other superhard cutting tool materials.

What is claimed is:

1. A reamer for reaming a tapered hole in a casting to provide a desired surface roughness of the walls defining the tapered hole , comprising:
a shank having at least one cutting tool of diamond material, the cutting face extending along a tapered length to a length corresponding to the length of the tapered hole , and the cutting face having a plurality of undulations along the cutting face, said undulations including alternating crests and troughs that machine the walls of the tapered hole and provide thereon a surface roughness within desired limits of surface roughness.

2. The reamer of claim 1 further comprising said undulations including troughs of semicircular shape.

3. The reamer of claim 2 further comprising said troughs having a radius of about 0.79 mm and each trough having a length of about 0.180 mm.

4. The reamer of claim 1 further comprising said troughs including a series of descending steps each including a curved down ramp and a flat tread that extend between the crests.

5. The reamer of claim 4 further comprising the radius of each of said curved down ramps is about 0.075 mm.

6. The reamer of claim 1 further comprising said troughs including a semicircular curved surface linked to an inclined flat surface.

7. The reamer of claim 1 further comprising said troughs including a declining flat surface that reclines along the length of the reamer and an inclined riser providing the crest.

8. The reamer of claim 7 further comprising the inclined riser having a radius of about 0.075 mm.

9. The reamer of claim 1 further comprising said troughs including a reclining flat and an inclining flat.

10. The reamer of claim 1 further comprising the trough of each of the undulations being provided by a flat surface and a curved surface.

11. The reamer of claim 1 further comprising the troughs of each of the undulations being provided by two flat surfaces.

12. A reamer for reaming a tapered hole in a casting to provide a desired surface roughness of the walls defining the tapered hole, comprising:
a shank having at least one cutting tool of diamond material, the cutting face extending along a tapered length to a length corresponding to the length of the tapered hole to be machined, and the cutting face having a plurality of undulations along the cutting face, said undulations having a series of troughs of semicircular shape connected successively at crests, that machine the wall of the tapered hole and provide thereon a surface roughness within desired limits of surface roughness.

13. The reamer of claim 12 further comprising said troughs having a radius of about 0.79 mm and each troughs having a length of about 0.180 mm.

14. A reamer for reaming a tapered hole in a casting to provide a desired surface roughness of the walls defining the tapered hole, comprising:
a shank having at least one cutting tool of diamond material, the cutting face extending along a tapered length to a length corresponding to the length of the tapered hole to be machined, and the cutting face having a plurality of undulations along the cutting face, said undulations having a series troughs and crests, said troughs defined by a reclining surface and a declining surface between each of the crests, to machine the wall surface of the tapered hole and provide thereon a surface roughness within desired limits of surface roughness.

15. The reamer of claim 14 further comprising the reclining surface being a flat surface and the inclining surface being a flat surface.

16. The reamer of claim 14 further comprising the reclining surface being a curved surface and the inclining surface being a flat surface.

17. The reamer of claim 14 further comprising the reclining surface being a flat surface and the inclining surface being a curved surface.

18. The reamer of claim 14 further comprising at least one of the surfaces being a curved surface having a radius of 0.075 mm.
